(19) United States
(12) Patent Application Publication
(10) Pub. No.: US 2015/0375451 A1
(43) Pub. Date: Dec. 31, 2015

(54) MULTI-COLOR 3D PRINTER

(71) Applicant: DISNEY ENTERPRISES, INC., Burbank, CA (US)

(72) Inventors: JEFFREY VORIS, PASADENA, CA (US); BENJAMIN FOSTER CHRISTEN, LOS ANGELES, CA (US); JORGE ALTED, ALTADENA, CA (US); DAVID W. CRAWFORD, LONG BEACH, CA (US)

(73) Assignee: DISNEY ENTERPRISES, INC., BURBANK, CA (US)

(21) Appl. No.: 14/318,768

(22) Filed: Jun. 30, 2014

(51) Int. Cl. B29C 67/00

(52) U.S. Cl. CPC B29C 67/0055; B29C 67/0085; B33Y 10/00

(57) ABSTRACT

A printer adapted for printing three dimensional (3D) objects with material having two or more colors. The printer includes a print head with an extrusion nozzle having an outlet, a mixing chamber upstream of the outlet, and a heated portion. The printer also includes a print bed with a surface for receiving material extruded from the outlet of the extrusion nozzle and a print material supply that is loaded with a filament of a plastic having a first color. The print head is adapted for drawing the filament into the heated portion to liquefy the plastic upstream of or in the mixing chamber. The printer includes a dye supply assembly fluidically coupled with the mixing chamber supplying dyes, such as inks, of two or more colors to the mixing chamber, whereby the liquefied plastic has its color changed from the first color to a second color prior to being extruded.

### BACKGROUND

1. Field of the Description.

The present invention relates, in general, to fabrication of three dimensional (3D) objects, and, more particularly, to a filament-based 3D printer (and corresponding 3D printing method) specially configured and operable to print 3D objects having two or more colors (e.g., to print multi-colored 3D objects).

2.Relevant Background

3D printing is an additive technology in which objects (or “printed 3D objects”) are created from a digital file. The digital file may be generated from software such as a computer aided design (CAD) program or another 3D modeling program or with a 3D scanner to copy an existing object that provides input to a 3D modeling program. To prepare the digital file for printing, software, provided on a printer-interfacing computer or running on the 3D printer itself, slices the 3D model into hundreds to thousands of horizontal layers. Typically, only the outer wall or “shell” is printed to be solid such that a shell thickness may be defined as part of modifying the 3D model for use in printing, and, during printing, the shell is printed as a solid element while the interior portions of the 3D object are printed in a honeycomb or other infill design (e.g., to reduce the amount of material that has to be printed to provide the printed 3D object).

When the prepared digital file of the 3D object is uploaded into the 3D printer, the 3D printer creates the object layer-by-layer. The 3D printer reads every slice (or 2D image) from the 3D model and proceeds to create the 3D object by laying down (or printing) successive layers of material until the entire object is created. Each of these layers can be seen as a thinly sliced horizontal cross section of the eventually completed or printed 3D object.

One of the more common 3D printer technologies uses fused deposition modeling (FDM) or, more generally, fused filament fabrication (FFF). FDM printers work by using a plastic filament (e.g., acrylonitrile butadiene styrene (ABS) or polylactic acid (PLA) provided as strands of filament that is 1 to 3 millimeters in diameter) that is unwound from a coil or spool mounted onto the printer housing. The plastic filament is used to supply material to a print head with an extrusion nozzle, e.g., a gear pulls the filament off the spool and into the extrusion nozzle. The extrusion nozzle is adapted to turn its flow on and off. The extrusion nozzle (or an upstream portion of the print head) is heated to melt the plastic filament as it is passed into, or through, the extrusion nozzle so that it liquefies. The pointed extrusion nozzle deposits the liquefied material in ultra fine lines (e.g., in lines that are about 0.1 millimeters across).

The extrusion head and its outlet are moved in both horizontal and vertical directions to complete or print each layer of the 3D model by a numerically controlled mechanism that is operated or controlled by control software running on the 3D printer (e.g., a computer-aided manufacturing (CAM) software package adapted for use with the 3D printer). The extruded melted or liquefied material quickly solidifies to form a layer (and to seal together layers of the 3D object), and the extrusion nozzle is then moved vertically prior to starting printing of the next layer. This process is repeated until all layers of the 3D object have been printed. The print surface, which may be called a print bed or build plate, is often heated also to avoid having the bottom layer of plastic of the 3D object curling up during printing.

Presently, 3D printers are significantly limited in the number of colors they can use to make 3D objects. For example, many 3D printers only have one print head, which means that objects are printed in one color (i.e., the color of the plastic filament). To print in more than one color, the print job has to be stopped and the filament switched out to provide filament of a different color. Some printers, though, may have two or more print heads each supplied by a different filament spool so that they can be used to print different colors without stopping a print job as the 3D printer can select different print heads to print different colors in the 3D object. However, the addition of two or more print heads along with separate material-supply spools makes the 3D printer much more complex to build and control, which, in turn, drives up its cost. Additionally, the color of the 3D object is still limited to the number of print heads and the colors in which the plastic filament is available. For example, most 3D printers will be limited to two or three colors unless the filament is changed out during the print process.

Hence, there remains a need for a new 3D printer that allows a 3D object to be printed in multiple colors. Preferably, such 3D printers would be relatively simple to operate and manufacture and would allow operators to continue to use digital files defining 3D models to print their multi-color 3D objects.

### SUMMARY

Briefly, a 3D printer is described that is adapted for printing multi-colored 3D objects. The 3D printer is configured to use a neutral-colored filament (e.g., a white plastic filament, a gray plastic filament, or other neutral-colored filament) as the supply material rather than a colored plastic filament as in prior 3D printers. The 3D printer provides a multi-colored printing functionality by coloring the neutral-colored filament immediately prior to printing, e.g., after it is pulled into a print head and liquefied by a heater (in the head or in the extrusion nozzle) but prior to extrusion from the extrusion nozzle.

To this end, two or more dye supply tanks (e.g., supplies of a dye such as an ink via an ink cartridge) are provided on or in the 3D printer housing, and the 3D printer controller operates to selectively output volumes of dye from the two or more dye (or ink) supply tanks to inject colored dye (e.g., ink or the like) into the extrusion nozzle (or into a mixing reservoir upstream from the extrusion nozzle) to color the liquefied print supply material (e.g., melted ABS, PLA, or plastic). In one embodiment, four dye supply tanks (e.g., ink cartridges) are provided to selectively supply red, green, blue, and black dyes (e.g., RGB and black inks or other colorants) to the print head to mix and color the neutral-colored filament material in or upstream of the extrusion nozzle (e.g., the term “neutral-colored” is intended to include any easy-to-dye (or color) plastic such as a white plastic, a clear plastic, a translucent plastic, or other easy-to-die plastic (which may even be a darker color such as black if the plastic takes on colors of the injected dye)). In this manner, the 3D printer may be operated or controlled to print in nearly any color (e.g., a color range similar to that found in an ink jet printer).

In some embodiments, the 3D printer takes a digital file as input that defines a full-color 3D model of an object, and the control software for the printer is adapted to recognize the color definitions of the 3D model and, in response, to selectively output a dye (such as an ink) from the dye supply tanks (e.g., ink cartridges) to print plastic material that has been colored or dyed to be a color matching that of the 3D model (e.g., first printing a first portion of a layer that is blue, second printing a second portion of the layer that is orange, third printing a third portion of the layer that is yellow, and so on). The 3D printer, therefore, can use a single print head to print liquefied plastic having any of plurality of colors while using a single filament type pulled from a single material supply spool.

More particularly, a printer is provided that is adapted for printing three dimensional (3D) objects with material having two or more colors. The printer includes a print head with an extrusion nozzle having an outlet, a mixing chamber upstream of the outlet, and a heated portion. The printer also includes a print bed with a surface for receiving material extruded from the outlet of the extrusion nozzle and a print material supply. The print material supply, e.g., a filament spool, that is loaded with a filament of a neutral-colored or easily stained/dyed plastic. Then, the print head can be adapted for drawing the filament into the heated portion to liquefy the neutral-colored plastic upstream of or in the mixing chamber. The printer also includes a dye supply assembly fluidically coupled with the mixing chamber to supply dye to the mixing chamber, whereby the liquefied plastic is colored by the supplied dye prior to being extruded from the outlet of the extrusion nozzle.

In some embodiments, the neutral-colored (or easily-colored/dyed) plastic is a white plastic (ABS or PLA or the like), a gray plastic, a beige plastic, or a light blue plastic. The supplied dye can be first provided with a first color and second provided with a second color differing from the first color. In some cases, the printer head is adapted to selectively draw or pump the supplied dye into the mixing chamber. Then, the dye supply assembly can include at least two dye tanks (or ink cartridges) containing dyes (e.g., inks) of at least two differing colors. In such embodiments, the printer head draws or pumps the supplied dye from the at least two dye tanks during at least two time periods to sequentially color the liquefied plastic at least two differing colors. In the same or other embodiments, the printer head draws or pumps the supplied dye from two or more of the at least two dye tanks concurrently to color the liquefied plastic by mixing dye of two or more colors. The printer may also include a controller adapted to process a digital file (e.g., defining a model of a 3D object including a plurality of colored elements) so as to define a plurality of print layers and to operate the print head to print the print layers with the supplied ink having colors matching colors of the plurality of colored elements.

### BRIEF DESCRIPTION OF THE DRAWINGS

FIG. 1 is a functional block diagram of a 3D printer system during printing operations to provide a multi-color 3D object with a single print head and a single material supply (e.g., a single spool loaded with neutral-colored plastic filament);

FIG. 2 is a flow diagram for a method of fabricating or printing a multi-colored 3D object using a filament-based 3D printer such as with use of the system of FIG. 1; and

FIGS. 3-6 illustrate perspective top, back, side, and bottom views, respectively, of a 3D printer of one useful design according to the present description.

### DETAILED DESCRIPTION

The inventors recognized that there were significant limitations with conventional three dimensional (3D) printers that rely on the use of different color plastic filament (or print materials) to print a 3D object in more than one color. To address these limitations, a 3D printer is described that uses a neutral-colored filament (or print material) that is fed into a single print head rather than having a different print head for each color.

Prior to extrusion from the print head outlet or extrusion nozzle, the 3D printer is adapted to dye or color the filament as or after it is liquefied or melted into liquid plastic. To this end, the 3D printer includes two or more ink cartridges (or other supplies of dye or coloring material with “ink” being one form of dye in the following description and claims) that can be used by a printer controller to color the liquefied or melted filament one of two or more colors (e.g., a color set or defined by a full color digital model of a 3D object). The colored and liquid plastic is then extruded from the extrusion nozzle of the print head, which has been positioned by the print controller relative to a build plate, so as to print a 3D object having two or more colors, e.g., a multi-colored 3D object.

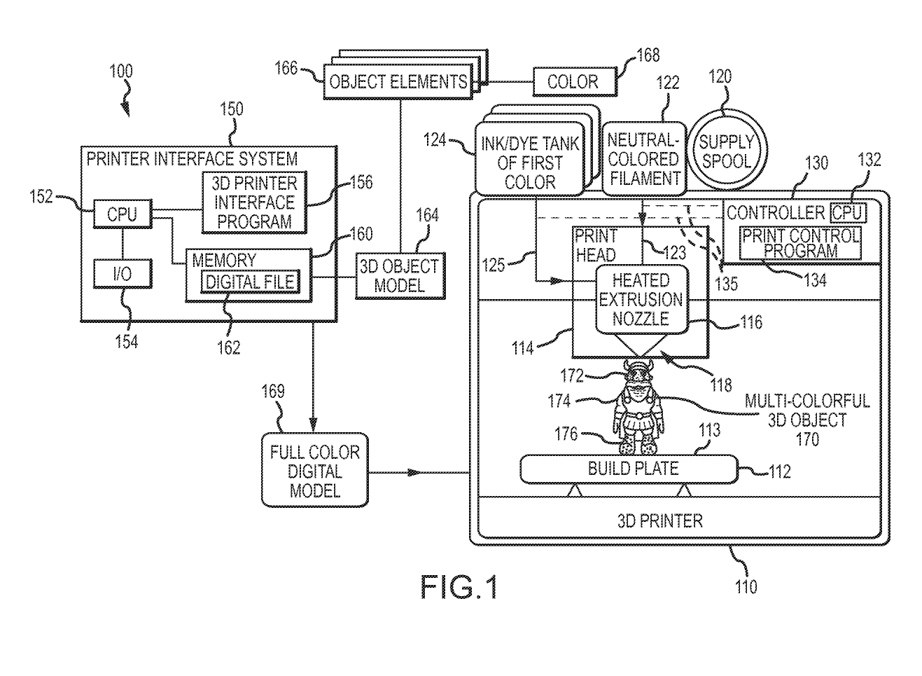

FIG. 1 illustrates a 3D print system 100 configured to allow an operator to print 3D objects having two or more colors while only requiring a single print head and a single print material supply (e.g., a single color of plastic filament). As shown, the system 100 includes a 3D printer 110 and a printer interface system 150. The printer interface system 150 may be a desktop computer, a workstation, a laptop or pad computer, or other computer device operable by a user of the 3D printer 110 to select and transmit a full-color digital model 169 to the 3D printer 110 for use in printing a 3D object 170. To this end, the printer interface system 150 includes a processor or central processing unit (CPU) 152 that operates or manages input and output (I/O) devices 154 such as a monitor, a touchscreen, a mouse, a keyboard, speakers, voice recognition devices, and the like that allow an operator or user of the system 150 to provide user input.

Particularly, the printer interface system 150 may include memory devices or data storage components (e.g., computer readable medium) 160 (or have access to such memory devices) that are managed by the processor 152 to store one or more digital files 162 that are used to print a 3D object 170. Also, the system 150 may use the CPU 152 to execute code or software (in computer readable medium such as RAM, ROM, or the like on the system 150) in the form of a 3D printer interface program 156. The interface program 156 may be downloaded onto the system 150 to allow an operator to interact with the 3D printer 110 and its print controller 130, and the 3D printer 110 may provide this software/program 156 upon a first link of the system 150 and the 3D printer 110 or the software/program 156 may be downloaded separately (e.g., by inserting a CD into the system 150, by accessing a web site associated with the 3D printer 110, or the like).

In practice, the 3D printer interface program 156 may be adapted to cause a series of interface screens to be presented by the system 150 and the I/O devices 154 to a user. The user may select a 3D object for printing by first generating a 3D model 164 of a 3D object, and this definition may also include setting a thickness for an outer shell of object 170 and a structural infill (e.g., one or more honeycomb patterns). Significantly, the 3D object model 164 may include a plurality of object elements or portions 166, and each of these object elements or portions 166 may be assigned a color 168. Alternatively, a color map may be provided in the digital file 162 defining colors for differing portions 166 of the 3D object model 164. The available colors for color definition 168 may vary to practice the system 100 but are at least two different colors. The available colors will depend upon the number of inks or dyes provided in the ink/dye tanks 124 and whether the print controller 130 is adapted to mix these differently colored inks or dyes. Typically, the color map or definition 168 will only apply to the shell of the model 164 and printed 3D object to limit the amount of ink or coloring dye that has to be used from tanks/cartridges 124 (e.g., with the infill being printed using plastic in the base color of the neutral-colored filament).

In some embodiments, two or more colored inks, such as red, green, and blue, are provided in tanks/cartridges 124 and the printer control program 134 is adapted to both select a single cartridge 124 (i.e., a single color) for use in printing but also to mix the colors to obtain a plurality of colors (i.e., nearly any color when all three cartridges are used). The printer interface program 156 may be adapted to provide a listing of available colors for color definitions 168 with a particular 3D printer 110 while some embodiments may configure the print control program 134 to recognize all colors in definition 168 and convert these to colors available with separate use or mixing of ink/dye tanks 124. Then, during operations, the printer interface system 150 is operable to communicate (wirelessly or in a wired manner) with the 3D printer 110 including transmitting a full color digital model 169 (or send the digital file 162 to the 3D printer) to the 3D printer 110 for use by the print control program 134 to print a multi-color 3D object 170 (in other cases, the print control program 134 accesses the digital file 162 in the memory 160, as needed for printing, rather than transmitting the model 169 to the 3D printer).

The 3D printer 110 includes a build plate or print bed 112 with an upper or exposed surface 113 upon which melted—and colored—plastic is printed from a print head 114 to form a multi-colored 3D object 170. This can be seen in FIG. 1 with the 3D object 170 having differing elements or portions 172, 174, 176, and each may be printed in a different color (or the shell portion of each object element/portion 172, 174, 176 may be printed in a different color). To this end, the 3D printer 110 includes a print head 114 with a heated extrusion nozzle 116 with a pointed tip/outlet 118 from which colored, liquid plastic is ejected or extruded to build up the object 170 layer-by-layer. In some cases, the heated extrusion nozzle 116 may include a heater or heat coil about a tube while in other cases a mixing chamber is provided immediately upstream of the tip/outlet 118 to allow mixing of ink/dye and liquefied or melted plastic to color the plastic prior to extrusion.

Further, the 3D printer 110 includes a print material supply in the form of a supply spool 120 upon which is wrapped or wound a length of plastic. Particularly, the plastic is provided as a neutral-colored filament 122 that can be drawn as shown by arrow 123 into the extrusion nozzle 116 where it is melted or liquefied by a heater. For example, the filament 122 may take the form of ABS, PLA, or other plastic useful in 3D printing that is white, gray, beige, light blue, and the like.

To provide color to this plastic filament 122, the 3D printer 110 includes two or more ink/dye cartridges or tanks 124 each containing a volume of a different color of ink or dye, which can be pumped or drawn as shown with arrow 125 into the print head 114 for mixing with the liquid/melted plastic provided by filament 122 (e.g., in a mixing chamber portion of the extrusion nozzle 116) downstream of the heater or within the heated portion of the nozzle 116. The ink from cartridges 124 may be fed 125 into the head 114 one at a time or, more typically, two or more at a time to allow more colors to be provided in the object 170 than the number of ink cartridges 124. For example, red, green, and blue ink may be provided in separate cartridges 124 to allow red, green, and blue plastic to be printed in elements/portions 172, 174, 176 or any color producible by mixing these three colors in equal or unequal portions.

The 3D printer 110 includes a controller 130 for interfacing with the printer interface system 150 so as to print a multi-colored 3D object 170 based on the digital file 162. The controller 130 includes a processor 132 executing or running software/code in the form of a print control program 134 (e.g., code in computer readable media accessible by the CPU 132). The print control program 134 is configured to selectively cause the filament 122 to be drawn (e.g., with gearing or the like) 123 from the spool 120 into the head 114 while also selectively injecting one or more colors of ink/dye from ink tanks/cartridges 124 (note, in some object portions 172, 174, or 176 no ink is added such that the object 170 includes the neutral-colored plastic in the shell and/or in the infill of the object 170). The print control program 134 recognizes color definitions 168 in the 3D object model 164 and uses this recognized information to select which cartridges 124 to use and what amounts to achieve a desired color. The print control program 134 also operates to move the print head 114 within a layer and to a new layer to print the 3D object 170 (e.g., to provide 3D printing, layer-by-layer as is known by those skilled in the art of 3D printing). In each layer of the 3D object 170, the plastic may be one, two, three, or more colors matching or exceeding the number of ink cartridges 124.

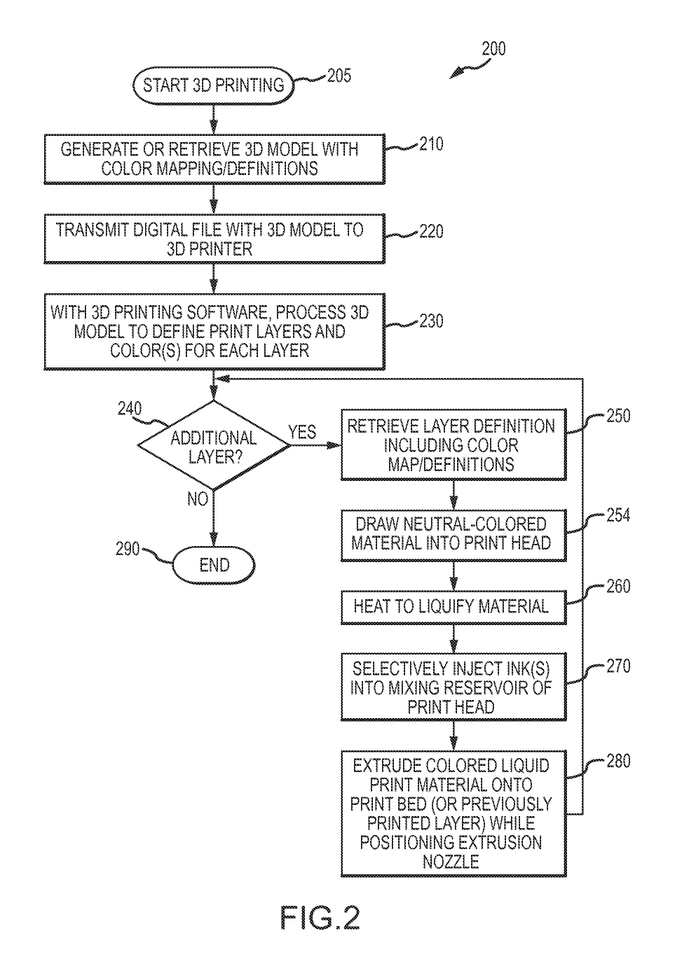

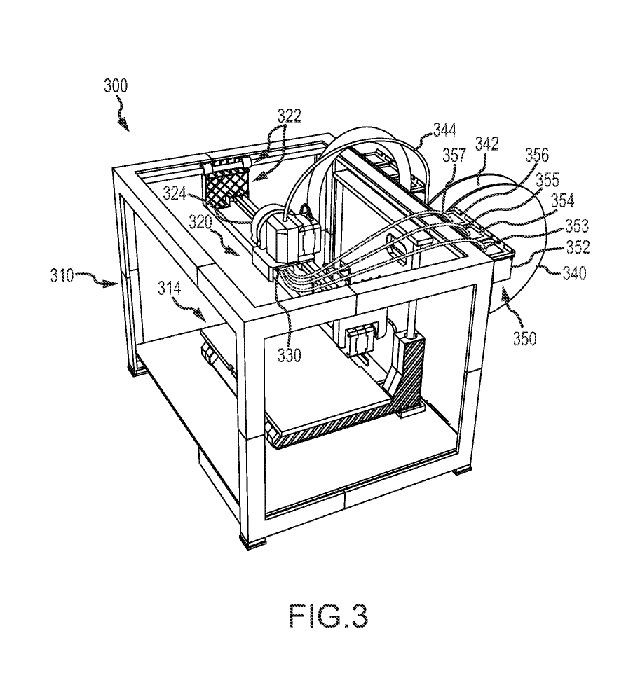

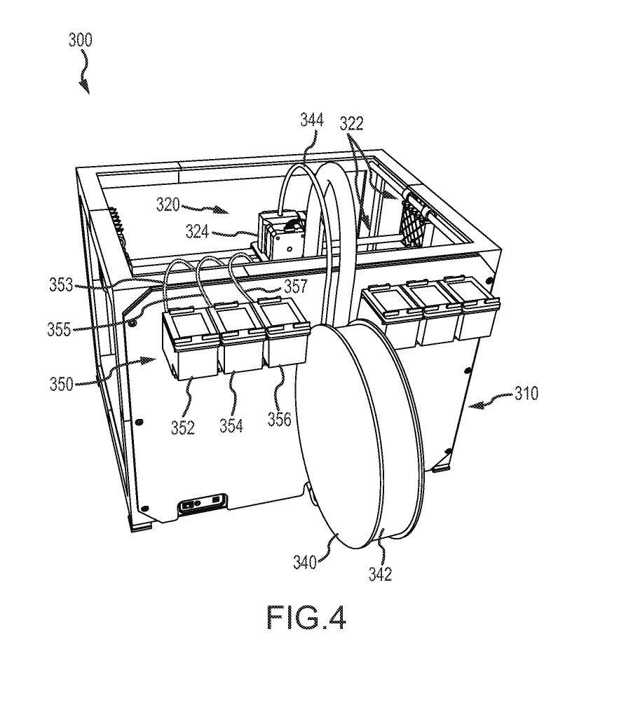

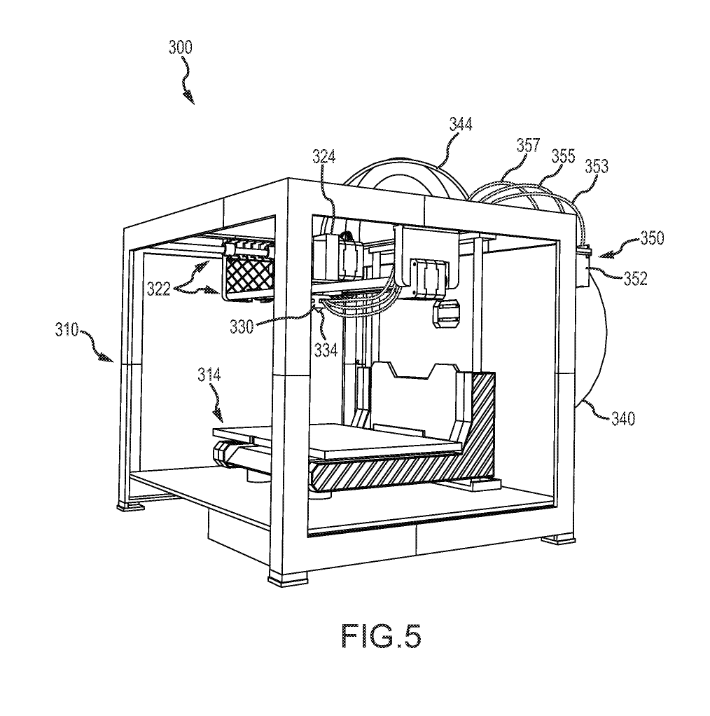

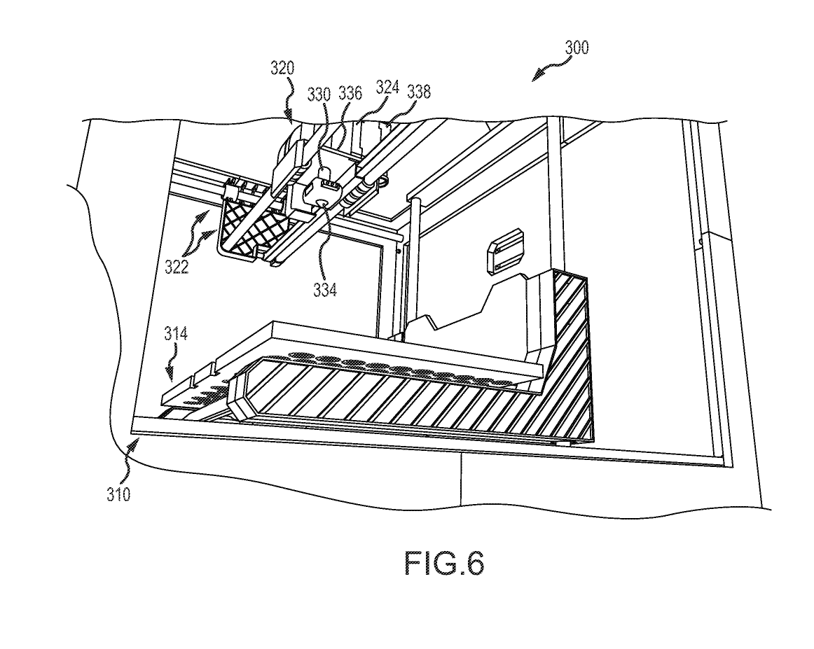

FIG. 2 illustrates a 3D printing method 200 that may be performed according to the present description such as by operation of the system 100 of FIG. 1 or the 3D printer shown in FIG. 3-6. The method 200 starts at 205 such as with communicatively linking a printer interface system/computer with a 3D printer, with installing/replacing colored-ink cartridges on the 3D printer for a desired set of print colors, with loading a print material onto a feed spool (e.g., a neutral-colored plastic filament), and with providing 3D printer-to-user device interface software on a user's printer interface system/computer. In some cases, the 3D printer also has to be allowed time to warm up including heating an extrusion nozzle and/or ink-and-plastic mixing chamber to a temperature within a useful plastic liquefying/melting range.

The method 200 continues at 210 with generating a 3D model of an object or retrieving/selecting a previously generated 3D model. The 3D model includes a mapping of colors onto at least the shell or exterior layer(s) of the 3D object or color definitions for each object element or region of the modeled 3D object. Again, as discussed above, the colors may be two or more in number. The method 200 continues at 220 with transmitting the digital file with the 3D model to a 3D printer configured for multi-colored printing as taught herein (or the controller of the 3D printer may access a memory device storing the digital file as needed in step 220 and during printing with such transmittal).

In step 230, the method 200 continues with the 3D printer control or printing software functioning to process the 3D model of the object. This processing includes defining print layers or thin slices of the 3D model of the object for use in printing a 3D object. In step 230, the 3D printing software identifies or recognizes different colors, which may include one, two, or more colors in each layer and may include assigning such colors to only the shell portion of each layer to limit the amount of ink used for 3D printing. Additionally, the processing in step 230 may involve converting a defined or chosen color for an object element or portion to a color that can be provided by the 3D printer or its current set or combination of colored inks/dyes (e.g., plastic coloring materials). These colors may then be mapped onto the differing regions or areas of the object layers.

The method 200 continues at 240 with determining (e.g., with the printing software running on the 3D printer) whether there are additional layers to be printed. If so, the method 200 continues at 250 with retrieving the next layer definition including color maps/definitions. At 254, the method 200 continues with drawing additional amounts of the neutral-colored print material (plastic filament or the like) into the print head such as by operating an electric motor to turn gears engaging the filament. At 260, the method 200 continues with heating the print material such as ABS plastic to liquefy it.

Then, at 270, the method 200 includes selectively injecting ink into the mixing chamber or reservoir (or heated portion of the nozzle or portion of the nozzle downstream of this heated portion) to color the neutral-colored and now liquid print material. This may involve injecting no ink when the printing is of the print material “as is” such as for the infill portion of the printed 3D object. In other cases such as in the shell portion of the printed 3D object, step 270 includes injecting one-to-three or more colored inks (again, it should be remembered that herein “ink” is one of any number of dyes which may be nearly any coloring material useful to color the print material) to achieve the color in the color map/definition corresponding to the present portion of the layer being printed (or present location of the head's outlet or extrusion nozzle).

At step 280, the method 200 includes extruding the now colored liquid print material onto the print bed or previously-printed layer while positioning the extrusion nozzle relative to the print bed to print the current object layer. Once a layer is completed, the method 200 continues at 240 with determining whether or not more layers need to be printed. If so, the method 200 involves raising the extrusion nozzle vertically away from the print bed to a new layer height/vertical position and repeating steps 250-280. If not, the method 200 ends at 290 such as with moving the print head away from the printed multi-color 3D object, turning the nozzle heater off, and indicating printing is completed (e.g., through a user interface on a printer interface computer system).

While the specific implementation of the 3D printer may vary to practice the invention, it may be useful to provide one exemplary configuration for a 3D printer that may operate to print multi-colored 3D objects with a single print head and with a single print material supply. FIGS. 3-6 illustrate various views of a 3D printer 300 useful for multi-colored printing. The 3D printer 300 includes a frame or a housing 310 upon which is a mounted a print bed or platform 314, which may be heated so as to minimize curling of the plastic during cooling/printing (e.g., for use with ABS plastic). The 3D printer includes a print head assembly 320 with a print head 324 and with a mounting and positioning assembly 322. The 3D printer 300 may include a motherboard for receiving 3D model data from a computer via a USB or similar communications port for from a memory card/device and for sending this data to controllers.

Specifically, the 3D printer 300 may include drive motors to control motion of the print head 324 with assembly 322 (or by movement of the build platform 314 in some alternative embodiments). For example, a Z-axis motor may be provided to raise and lower the print head 324 in the vertical direction relative to the upper surface of the build platform 314 and also include X-axis and Y-axis motors to move the print head 324 side-to-side and front-to-back relative to the build platform 314 and previously printed layers of a 3D object on the platform 314. Stepper motor controllers may be included to translate commands from the controller on the motherboard into pulses to precisely move the stepper motors and accurately position the print head 324.

The printer head 324 includes a heater on a mixing chamber or extrusion end 330 along with a print nozzle 334. Print material is provided with a spool 340 mounted onto the frame 310 to be able to spin or rotate, and a length or amount 342 of plastic filament 344 is wound onto the spool. As discussed above, the plastic filament 344 is a neutral color such as white or clear/translucent that can easily be colored for printing portions of a 3D object's shell. The print head assembly 320 may include a stepper motor to draw in the plastic filament 344 into a tube 336 upstream of the outlet/nozzle 334, and the heater of the extrusion end 330 may heat the drawn or fed in filament 344 to a predefined temperature range to liquefy or melt it. For example, a cartridge may be used to apply heat to a metal core that melts the filament/plastic 344, and the core may be wrapped in insulation.

The melted plastic is then pushed through the nozzle 334 in a thin stream so as to build up the 3D object on the build platform 314 in layers (e.g., each layer may be about 0.3 millimeters thick). Prior to extrusion, though, the melted plastic may be dyed or colored with one or more inks to provide a printed, multi-colored 3D object on the build platform 314. To this end, the 3D printer 300 includes an ink supply assembly 350 with first, second, and third ink cartridges or tanks 352, 354, 356 that are each filled with a different color of ink (e.g., red, green, and blue ink). The printer head assembly 320 (or the cartridges themselves) is adapted to selectively draw volumes of the ink through the feed or supply lines (tubes) 353, 355, 357, which lead from the cartridges 352, 354, 356 to inlet ports or an ink input/inlet adapter 338 on the mixing chamber or extrusion end 330 of the printer head 324. In this manner, the melted plastic is printed out in its base, neutral color or is first colored to be one of the colors of the ink in one of the cartridges 352, 354, 356 or a color obtained by mixing the same or differing quantities of two or more of the inks.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The ink tanks or cartridges provided on the 3D printer may be used to provide ink of one, two, or more colors. One embodiment selectively provides ink that is red, green, blue or a mixture of these colored inks with a separate black ink cartridge in some embodiments. In another case, the CMYK color model is used, and the 3D printer includes four ink tanks/cartridges providing four colors of ink: cyan, magenta, yellow, and black. These four colors can then be used independently to provide liquid plastic of one of these four colors or mixed in numerous combinations to provide liquid plastic with a wide variety of colors. The ink should be selected for its compatibility with the particular plastic (ABS, PTA, or the like) used in the 3D printer. For example, the ink may be an aqueous ink, a solvent ink, a UV-curable ink, a dye sublimination ink, or other plastic-coloring ink or dye.

The 3D printer may be designed to build upon the Fused Filament Fabrication (FFF) method. Particularly, a 3D design of an object, including full color definitions or mapping of object elements (or at least their outer surfaces), which can be used to print liquefied plastic that has been colored to match the definitions/mapping in each print layer (or at least in each layer's shell). The controller and/or software of the 3D printer translate the 3D design into instructions for the 3D printer. The 3D printer then heats the neutral-colored filament, mixes it with ink(s) selected based on color mapping/definitions of the 3D design of the object, and extrudes it out through a nozzle on a surface to build a 3D object colored layer-by-colored layer (with the surface optionally being heated to control cooling and subsequent shrinking of lower layers). The neutral-colored filament may be fed to the print head (e.g., into the print head's extruder) via guide tubes in some embodiments of the 3D printer.

We claim:

1. A printer for printing three dimensional (3D) objects, comprising:
a print head with an extrusion nozzle having an outlet, a mixing chamber upstream of the outlet, and a heated portion;
a print bed with a surface for receiving material extruded from the outlet of the extrusion nozzle;
a print material supply loaded with a filament of a plastic having a first color, wherein the print head is adapted for drawing the filament into the heated portion for liquefying the neutral-colored plastic upstream of or in the mixing chamber; and
a dye supply assembly fluidically coupled with the mixing chamber to supply dye to the mixing chamber, whereby the liquefied plastic is colored a second color differing from the first color by the supplied dye prior to being extruded from the outlet of the extrusion nozzle.

2. The printer of claim 1, wherein the plastic comprises a white plastic, a gray plastic, a beige plastic, a light blue plastic, a clear plastic, or a translucent plastic.

3. The printer of claim 1, wherein the supplied dye is first provided with a first color and second provided with a second color differing from the first color of the supplied dye.

4. The printer of claim 1, wherein the printer head is adapted to selectively draw or pump the supplied dye into the mixing chamber.

5. The printer of claim 4, wherein the dye supply assembly comprises at least two dye supply tanks containing inks of at least two differing colors.

6. The printer of claim 5, wherein the printer head draws or pumps the supplied dye from the at least two dye tanks during at least two time periods to sequentially color the liquefied plastic at least two differing colors.

7. The printer of claim 5, wherein the printer head draws or pumps the supplied dye from two or more of the at least two dye supply tanks concurrently to color the liquefied plastic by mixing dye of two or more colors.

8. The printer of claim 1, further comprising a controller adapted to process a digital file, defining a model of a 3D object including a plurality of colored elements, to define a plurality of print layers, and to operate the print head to print the print layers with the supplied ink having colors matching colors of the plurality of colored elements.

9. A 3D printer, comprising:
a supply spool loaded with a neutral-colored plastic filament;
a set of tanks each containing a different colored ink; and
a heated extrusion nozzle liquefying a portion of the neutral-colored plastic filament, first mixing the liquefied portion of the plastic filament with ink from a first one of the tanks, and second mixing the liquefied portion of the plastic filament with ink from a second one of the tanks.

10. The 3D printer of claim 9, wherein the set of tanks comprises four tanks containing red ink, green ink, blue ink, and black ink, respectively.

11. The 3D printer of claim 9, further comprising a controller processing a digital model, defining a 3D object, to define a plurality of print layers, wherein the first and second mixing are performed based on first and second colors defined for one or more of the print layers.

12. The 3D printer of claim 11, wherein the controller further positions the heated extrusion nozzle relative to a print bed based on the defined plurality of print layers prior to extruding the liquefied portion of the plastic filament after the first or second mixing with the ink.

13. The 3D printer of claim 9, wherein the first and second mixing are performed concurrently, whereby the liquefied portion is colored by the ink from the first and second ones of the tanks.

14. The 3D printer of claim 9, wherein the neutral-colored plastic filament comprises white ABS plastic.

15. A method for printing a multi-colored 3D object, comprising:
generating or retrieving a digital model of the 3D object including a plurality of object elements having two or more colors;
processing the digital model to define a plurality of print layers; and
operating a 3D printer to extrude a liquid plastic to sequentially form each of the print layers, wherein the 3D printer operating includes melting plastic and coloring the melted plastic with two or more colored inks to provide a colored, liquid plastic having one of the two or more colors associated with the object elements.

16. The method of claim 15, wherein at least one of the print layers is formed, during the operating of the 3D printer, with plastic of two or more colors in a shell section and with the melted plastic without the two or more colored inks in an infill section.

17. The method of claim 15, wherein the two or more colored inks are provided by selectively injecting ink from two or more ink cartridges each containing differing colored inks.

18. The method of claim 15, wherein the plastic comprises a neutral-colored plastic.

19. The method of claim 18, wherein the neutral-colored plastic comprises white, gray, beige, or light blue plastic.

20. The method of claim 15, wherein the plastic is provided by selectively drawing a filament from a single supply spool.
